(19) United States
(12) Patent Application Publication
(10) Pub. No.: US 2004/0261564 A1
(43) Pub. Date: Dec. 30, 2004

(54) Steering column device for vehicle

(75) Inventor: Kenji Sato, Gunma (JP)

Correspondence Address: SUGHRUE MION, PLLC, 2100 PENNSYLVANIA AVENUE, N.W., SUITE 800, WASHINGTON, DC, 20037, US

(73) Assignees: NSK LTD.; NSK STEERING SYSTEMS CO., LTD.

(21) Appl. No.: 10/872,411

(22) Filed: Jun. 22, 2004

(30) Foreign Application Priority Data
Jun. 24, 2003 (JP) P. 2003-179920

(51) Int. Cl. B62D 1/16

(52) U.S. Cl. 74/492

(57) ABSTRACT

A vehicle steering column device for adjusting a position of a steering wheel at a desired position. The device includes: a steering column connected to the steering position; a position adjustment mechanism for adjusting a position of the steering column; the position adjustment mechanism including a clamping section for clamping the steering column at a desired position; and a flip-up mechanism for causing flip-up of the steering wheel, the flip-up mechanism separately disposed at a position closer to the steering wheel with respect to the clamping section.

### BACKGROUND OF THE INVENTION

1. Field of the Invention

The present invention relates to a vehicle steering column device including a steering wheel position adjusting mechanism for improving drivability and a flip-up mechanism for facilitating getting in/out action of a driver.

2. Background Art

A vehicle steering column device desirably allows adjustment of a steering wheel position so as to adapt to the physical constitution, driving position, or the like of a driver, because it is used (steered) by an indefinite driver. In light of this desire, vehicles adopting a tilt mechanism or a telescopic mechanism are increased in number.

The tilt mechanism is for adjusting the position of a steering wheel substantially in the vertical direction, and comprises a tilt pivot which supports a steering column in a swaying manner; tilt clamping means which clamps the steering column at a desired position (ire., a swaying angle); and the like.

The telescopic mechanism is for adjusting the position of a steering wheel in the fore-and-aft direction (in an axial direction of a steering shaft), and comprises a telescopic portion, such as a double-pipe-type telescopic portion, for the use in telescoping the steering shaft; telescopic clamping means for clamping the steering column at a desired position (i.e., fixing a desired telescopic length); and the like.

### SUMMARY OF THE INVENTION

(Steering Device of Swingable Tilt Type)

A steering column device of swingable tilt type is disposed with the tilt center distant from the driver. For this reason, position adjustment results in a small change in steering angle, and relatively superior drivability is achieved.

However, in a view of ease of getting in/out action of the driver, the swingable-tilt/telescopic-type steering mechanism involves a problem in that an operating angle (i.e., a swaying angle) cannot be set to a large value in order to avoid interference with an instrument panel or the like, whereby a moving distance (i.e., the amount of swaying) of the steering wheel becomes small, thereby hindering ease of getting in/out action of the driver to some extent.

(Steering Device of Oscillatory Tilt Type)

A steering column device of oscillatory tilt type is disposed with the tilt center close to the driver. For this reason, the operating angle (i.e., the swaying angle) can be set to a large value to avoid interference with an instrument panel or the like, whereby the moving distance (i.e., the amount of swaying) of the steering wheel becomes large. Therefore, ease of getting in/out action of the driver is comparatively superior.

However, in view of drivability, the oscillatory-tilt-type steering column device involves a problem in that position adjustment results in a large change in steering angle, which is not preferable.

(Steering Device of Oscillatory Tilt Type with Memory)

As described above, the steering column device of oscillatory tilt type allows relatively superior ease of getting in/out action; however, it involves an inconvenience in that a driver must re-adjust the position of the steering wheel when returning to his/her seat.

In this respect, a steering column device disclosed in Japanese Patent No.2558105 is free from the inconvenience of re-adjustment, because it is provided with a memory mechanism.

However, it has disadvantages, such as increased production cost due to the complicated structure of the memory mechanism and an increased number of components.

(Steering Device of Oscillatory Tilt/telescopic Type)

The steering device of telescopic type has increasingly been adopted in recent years. In the case where the telescopic-type steering device is added while placing importance on ease of getting in/out action of the driver, as shown in JP-UM-B-8-10068, a telescopic clamp mechanism is disposed at a place other than where the tilt-type mechanism is disposed. Consequently, control levers are provided in a total number of two.

Adding the memory mechanism disclosed Japanese Patent No.2558105 to the device may arise disadvantages, including an increase in the total number of the control levers to three, increased complexity of the mechanism, and rendering operation by a driver complicated and confusing.

The present invention has been conceived in view of the above circumstances and provides a vehicle steering column device which is based on a steering mechanism of swingable tilt/telescopic type exhibiting extremely excellent drivability and which can considerably enhance ease of getting in/out action of the driver while minimizing the total number of control levers.

The invention provides a vehicle steering column device for adjusting a position of a steering wheel at a desired position, the device includes: a steering column connected to the steering position; a position adjustment mechanism for adjusting a position of the steering column; the position adjustment mechanism including a clamping section for clamping the steering column at a desired position; and a flip-up mechanism for causing flip-up of the steering wheel, the flip-up mechanism separately disposed at a position closer to the steering wheel with respect to the clamping section.

According to the invention, the flip-up mechanism for causing flip-up of the steering wheel is provided separately at a position closer to the steering wheel side in relation to a position of a clamping section of a position adjustment mechanism. Hence, the vehicle steering column is caused to be based on a steering mechanism of swingable-tilt/telescopic type exhibiting extremely excellent drivability, and can also considerably enhance ease of getting in/out action of the driver while suppressing the total number of control levers to a great extent (e.g., to two).

Preferably, the flip-up mechanism includes: a stationary bracket fixed to the steering column; a swaying bracket disposed in a swayable manner on a vehicle rear side of the stationary bracket; and a nipped piece nipped between the stationary bracket and the swaying bracket, the nipped piece capable of coming out of a gap between the stationary bracket and the swaying bracket at a time of flip-up of the steering wheel.

Preferably, the stationary bracket and the tilt bracket are brought into contact with each other through a contacting surface at the time of flip-up of the steering wheel; and a tilt angle of the contacting surface is set to be an angle of friction or less.

Preferably, the vehicle steering column device further includes; a steering lock of an electric type having a lock section that is provided separately from a key cylinder section; wherein the lock section is placed on the steering column.

Preferably, the position adjustment mechanism further includes a tilt clamping bolt having an axis that intersects substantially perpendicular to an axis of a steering shaft; and the flip-up mechanism has a flip-up spring disposed at a position above the steering column and above the stationary bracket and the swaying bracket.

Preferably, the position adjustment mechanism has a tilt swaying center disposed at a position lower than the clamping section of the steering column.

Preferably, the flip-up mechanism further includes a flip-up control lever for actuating the nipped piece through operation performed by an operator.

Preferably, the flip-up control lever is attached on the swaying bracket.

Preferably, the position adjustment mechanism employs an adjustment of tilt type for adjusting the position of the steering column.

Preferably, the position adjustment mechanism employs an adjustment of telescopic type for adjusting the position of the steering column.

Preferably, the position adjustment mechanism employs an adjustment of tilt/telescopic type for adjusting the position of the steering column.

### BRIEF DESCRIPTION OF THE DRAWINGS

The present invention may be more readily described with reference to the accompanying drawings:

FIG. 1 is a longitudinal cross-sectional view of a vehicle steering column according to a first embodiment of the invention;

FIG. 2 is a partially cutaway plan view of the vehicle steering column device shown in FIG. 1;

FIG. 3A is a cross-sectional view taken along line IIIa-IIIa of FIG. 1;

FIG. 3B is a cross-sectional view taken along line IIIb-IIIb of FIG. 1;

FIG. 4 is a cross-sectional view taken along line IV-IV of FIG. 1;

FIG. 5 is a cross-sectional view taken along line V-V of FIG. 1;

FIG. 6 is a longitudinal cross-sectional view taken along line V-V of FIG. 1, showing the steering wheel in a flip-up position;

FIG. 7 is a longitudinal cross-sectional view of the vehicle steering column device shown in FIG. 1, showing the steering wheel in the flip-up position;

FIG. 8 is a longitudinal cross-sectional view of a vehicle steering column according to a second embodiment of the invention;

FIG. 9 is a longitudinal cross-sectional view of a vehicle steering column according to a third embodiment of the invention; and

FIG. 10 is a cross-sectional view taken along line X-X of FIG. 9.

### DETAILED DESCRIPTION OF THE PREFERRED EMBODIMENTS

### Modes for Implementing the Invention

Next, a vehicle steering column device according to embodiments of the present invention will be described with reference to drawings.

(First Embodiment)

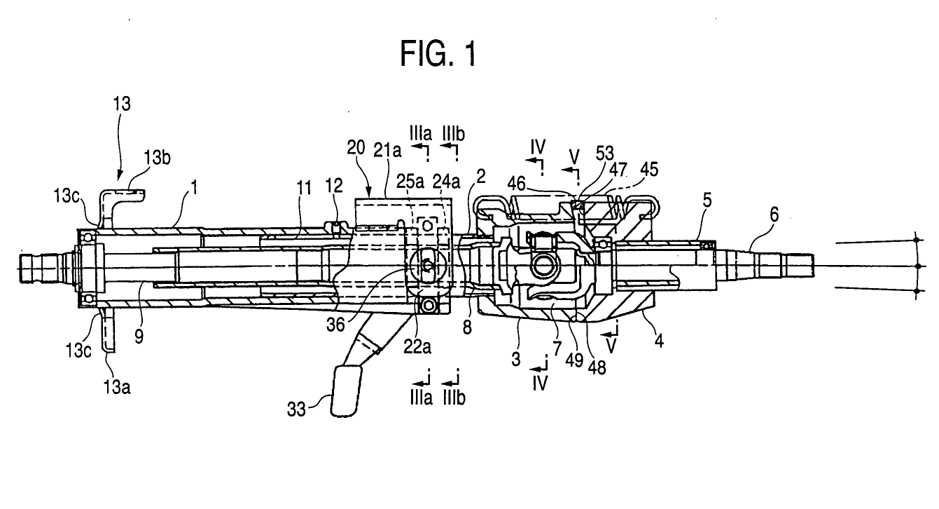

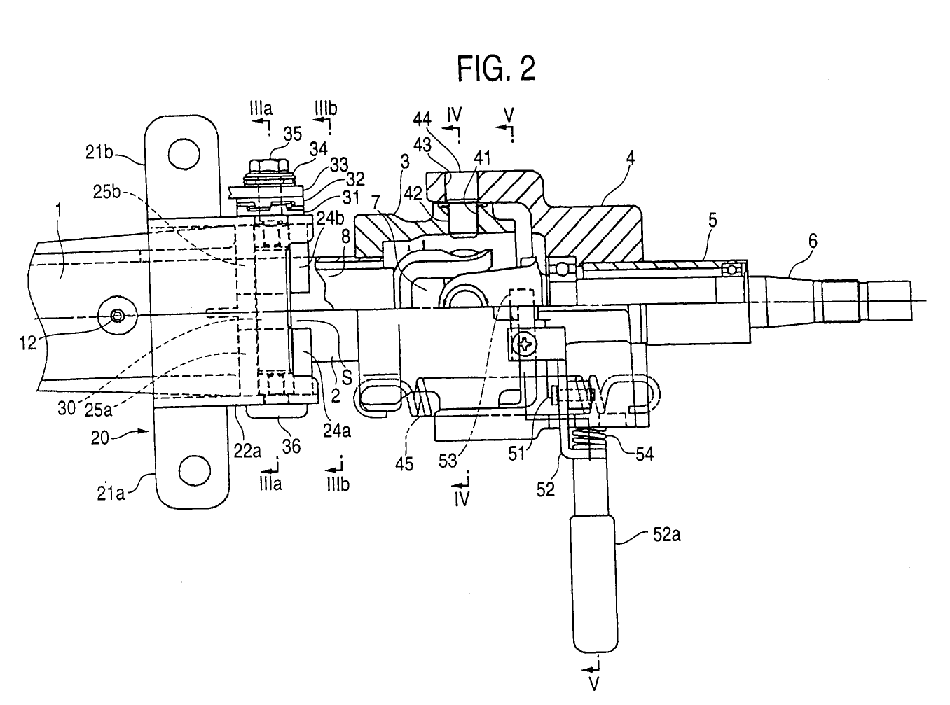

FIG. 1 is a longitudinal cross-sectional view of a vehicle steering column according to the first embodiment of the invention. FIG. 2 is a partially cut away plan view of the vehicle steering column device shown in FIG. 1.

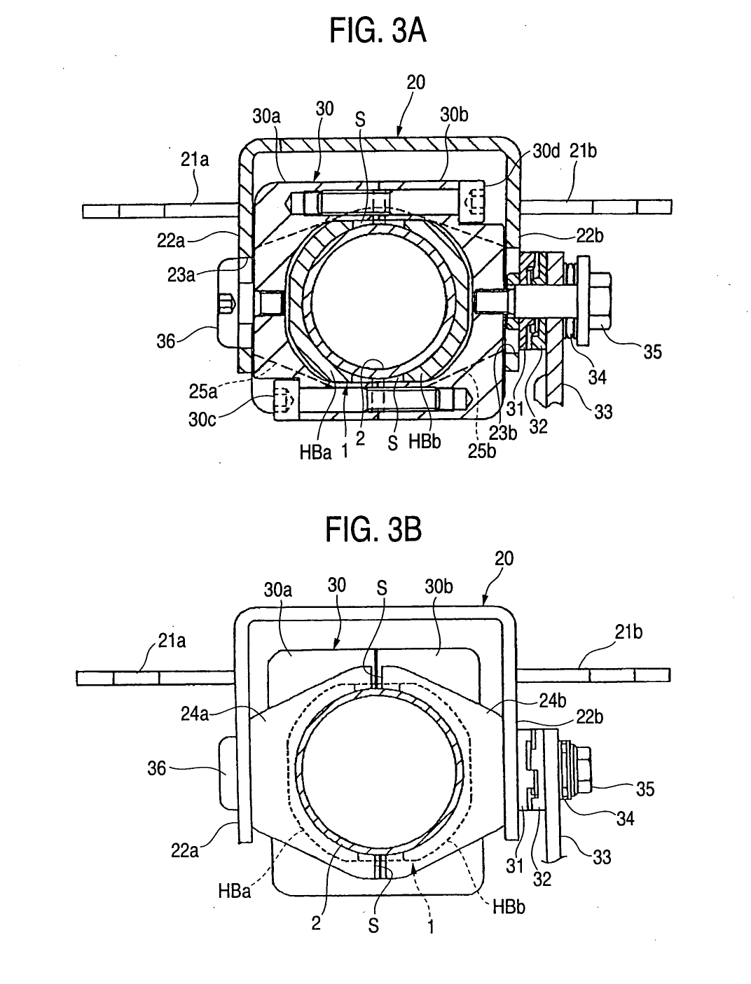

FIG. 3A is a cross-sectional view taken along line IIIa-IIIa of FIG. 1, and FIG. 3B is a cross-sectional view taken along line IIIb-IIIb of FIG. 1.

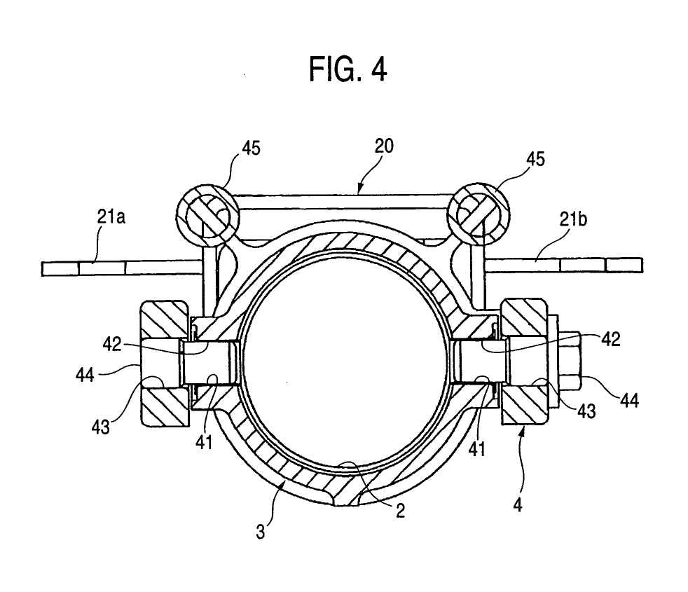

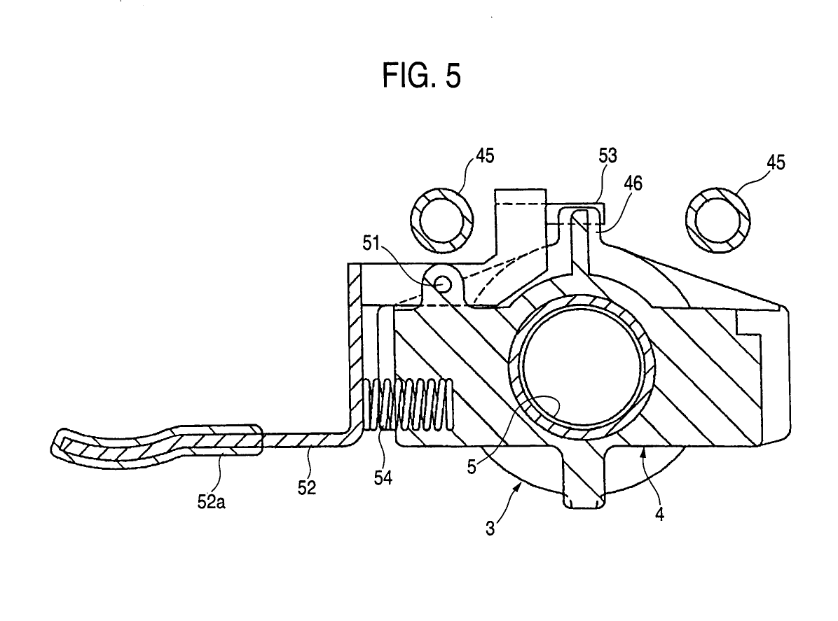

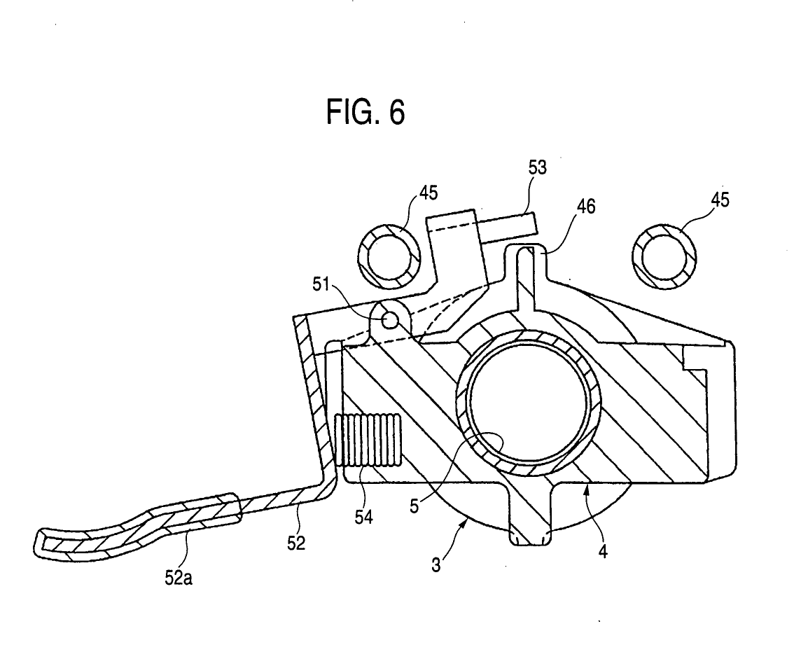

FIG. 4 is a cross-sectional view taken along line IV-IV of FIG. 1. FIG. 5 is a cross-sectional view taken along line V-V of FIG. 1. FIG. 6 is a longitudinal cross-sectional view taken along line V-V of FIG. 1, for showing a steering wheel in a flip-up position.

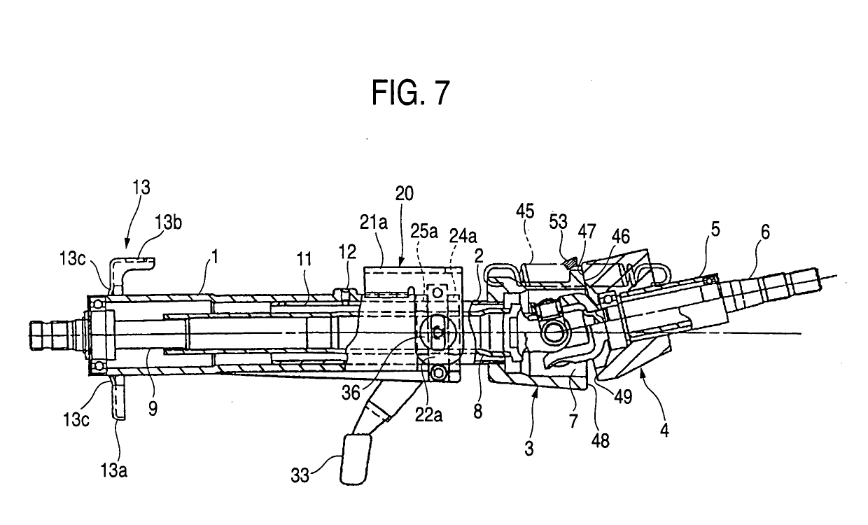

FIG. 7 is a longitudinal cross-sectional view of the vehicle steering column device shown in FIG. 1, showing a steering wheel in a flip-up position.

As shown in FIG. 1, the steering column comprises a lower column 1 to be fixed on a vehicle body; a telescopic column 2 provided slidably with respect to the lower column 1; a middle bracket 3 (a stationary bracket) fixed on a portion of the telescopic column 2 oriented toward the rear end of the vehicle (hereinafter simply called a “vehicle-rear side”); an upper bracket 4 (a swaying bracket) swingably with respect to the middle bracket 3; and an upper column 5 provided on the vehicle-rear side of the upper bracket 4.

A steering shaft comprises an upper shaft 6 on whose rear end a steering wheel (unillustrated) is attached and which rotatably supports the upper bracket 4 and the upper column 5; a slider tube 8 which is connected to the upper shaft 6 by way of a universal joint 7 and which slides at the time of telescopic adjustment; and a lower shaft 9 which is spline-engaged, or the like, to the slider tube 8 and which rotatably supports the lower column 1.

Moreover, an axially-extending telescopic stopper groove 11 is formed in an upper portion of the telescopic column 2, and a telescopic stopper 12 provided on the lower column 1 is engaged with the telescopic stopper groove 11. As a result, the range of the telescopic adjustment in the axial direction is defined, and rotation of the telescopic column 2 relatively to the telescopic stopper groove 11 in the course of telescopic adjustment is prevented.

A tilt-hinge lower bracket 13 is also provided on a vehicle-front side of the lower column 1. A universal joint (omitted from the drawing) is connected to a tip portion of the lower shaft 9, and a steering gear (omitted from the drawing) is attached to the universal joint by way of an intermediate shaft (omitted from the drawing) so that wheels can be consequently steered by way of a tie rod (omitted from the drawing) or the like.

The tilt-hinge lower bracket 13 is formed in a substantially L-shape when viewed from the side, and is provided with a main body section 13a passing through the lower column 1 for effecting tilt movement; and a body mount section 13b for installing the steering column onto the body on the top face thereof.

In the center of the main body section 13a, a round hole (unillustrated) having a pair of tongues 13c, 13c on the top and the bottom thereof is provided. As the lower column 1 is pressed into the roundhole, the tongues 13c, 13c are elastically deformed, and the centers of the tongues 13c, 13c serve as a tilt pivot of the lower column 1. Consequently, while being supported by the pair of tongues 13c and 13c, the lower column 1 can tilt about the centers of the tongues; that is, the tilt pivot, in a swaying manner.

In the present embodiment, a position adjustment mechanism of swingable tilt/telescopic type is provided. The position adjustment mechanism is of a type where an axis of tilt clamping bolts (35 and 36) and an axis of the steering shaft (6 through 9) intersect substantially perpendicularly. The clamping mechanism of the position adjustment mechanism is provided on an upper body-side bracket 20 disposed on the vehicle-rear portion of the lower column 1.

As shown in FIGS. 3A and 3B, an upper-body-side bracket 20 is provided with a pair of body mount sections 21a and 21b. A pair of opposing left and right flat plate sections 22a and 22b, which extend in substantially vertical directions, are provided at respective areas from which the pair of body mount sections 21a and 21b extend toward the rear side of the vehicle. A pair of elongated holes for tilting 23a and 23b are formed in the pair of opposing flat plate sections 22a and 22b, respectively.

A pair of left and right half-body sections HBa and HBb, which are laterally divided into equal half-bodies in an axial direction and have upper and lower slits S (slots), are formed at the vehicle-rear portion of the lower column 1.

The half-bodies HBa and HBb respectively have two pairs of clamping portions 24a and 24b, and 25a and 25b at provided areas when viewed in the front and rear direction of the vehicle. Slits S (slots) are formed between the clamping portions 24a and 24b and between the clamping portions 25a and 25b.

By virtue of this configuration, the widths of the pair of opposing flat plate sections 22a and 22b of the upper body-side bracket 20 are shortened. Consequently, when the two pairs of clamping portions 24a and 24b, and 25a and 25b are pressed to be closer to each other, the diameter of the lower column 1 (the pair of half-body sections HBa and HBb) is shortened to thus clamp the telescopic column 2 of the upper side.

A substantially annular tension member 30 is provided at a position on outer circumferences of the pair of right and left half-body portions HBa and HBb and between the two pairs of clamping portions 24a and 24b, and 25a and 25b when viewed in the fore-and-aft direction of the vehicle.

The tension member 30 is substantially annular shaped in an assembled state and is-divided into two halves; that is, a left halt 30a and a right half 30b. Specifically, the left half 30a and the right half 30b are fastened together with a pair of bolts 30c and 30d, thereby constituting an integrated tension member 30 of a substantially annular shape.

An adjustment bolt 35 is secured to one side of the tension member 30 through screw engagement by way of a cam mechanism including a first cam member 31 and a second cam member 32, a control lever 33 for tilt telescopic control, and a thrust bearing 34. On the opposite side of the tension member 30, the tilt clamping bolt 36 is secured by means of screw-engagement.

Male screw portions of the tilt clamping bolts 35 and 36 are formed so as to be crimped or provided with release-preventing resins.

The cam mechanism comprises the unrotational first cam member 31, which has protruding portions and recessed portions and which is engaged with one of the elongated hole 23b and slidable with respect to the opposing flat plate section 22b; and the second cam member 32, which has protruding portions and recessed portions and which rotates together with the control lever 33.

Operation of tilt telescopic adjustment of the steering column device according to the embodiment will now be described. The control lever 33 may be released by pulling or by pushing in FIG. 1; however, it is preferably released by pulling.

When the control lever 33 is rotated in a fastening direction, the protruding portions of the first cam member 31 and the second cam member 32 are engaged with each other as shown in FIGS. 3A and 3B, to thus generate pressing force in a direction urging the two members away from each other.

In response, the right flat plate section 22b, which is one of the opposing flat plate sections, is pressed by the first cam member 31 and displaced to the left in FIGS. 3A and 3B.

Meanwhile, one of the adjustment bolts 35displaces the other tilt clamping bolt 36 to the right by way of the tension member 30. Consequently, the remaining flat plate section 22a is displaced to the right in FIGS. 3A and 3B.

When the pair of opposing flat plate sections 22a and 22b are moved to the fastening direction (i.e., in a direction causing narrowing of the gap thereof), the two pairs of clamping portions 24a and 24b, and 25a and 25b are pressed to be closer to each other as shown in FIG. 3B. As shown in FIG. 3A, the diameter of the lower column 1 (the pair of half-bodies HBa and HBb) is reduced, whereby the telescopic column 2 on the upper side is fastened. Thus, tilt/telescopic fastening is performed.

In contrast, when the control lever 33 is rotated in a releasing direction, the protruding and recessed portions of the first cam member 31 and those of the second cam member 32 mesh with each other and are displaced in a direction to become closer, whereby the gap between the first member 31 and the second member 32 is narrowed.

As a result of the pressing on the opposing flat plate section 22b by the first cam member 31 having been released, the pressing of the second cam member 32 against the opposing flat plate section 22a by way of the tilt clamping bolt 35, the tension member 30, and the/tilt adjustment bolt 36 is released.

As described above, when the pressing to the pair of opposing flat plate sections 22a and 22b is released, the two pairs of clamping portions 24a and 24b, and 25a and 25b are moved away from each other. Accordingly, the diameter of the lower column 1 (the pair of half-bodies HBa and HBb) is expanded, to thus release the fastening to the telescopic column 2 of the upper side. Consequently, the tilt telescopic fastening is released, whereby the driver can perform a tilt or a telescopic adjustment.

In the embodiment, as shown in FIGS. 1, 2, 4, and 7, the upper bracket 4 (a swaying bracket) is formed so as to allow swaying in relation to the middle bracket 3 (a stationary bracket). Accordingly, flip-up tilting of the steering shaft (omitted from the drawing) can be performed.

Specifically, a pair of tilt center pins 44 passing through a pair of through holes 43 of the upper bracket 4 (swaying bracket) are securely fitted in a pair of through holes 41 formed on the middle bracket 3 (the stationary bracket) by way of a dry bush 42. Consequently, the upper bracket 4 (the swaying bracket) is allowed to sway in relation to the middle bracket 3 (the stationary bracket). Note that during the course of a flip-up tilting operation the tilt center corresponds to the rotational center of the pair of tilt center pins 44 and that of the universal joint 7.

Two flip-up springs 45 of the flip-up mechanism are disposed at positions over the upper side of the steering column and the upper side of the middle bracket 3 and the upper bracket 4. Respective ends of the flip-up springs 45 are engaged with unillustrated engaging portions of the two brackets 3 and 4. By means of this configuration, when a flip-up locking of the flip-up mechanism is released, as will be described later, the upper bracket 4 on the steering wheel side is caused to flip up automatically by a spring tension of the flip-up springs 45. Note that the flip-up springs 45 have no protruding portion on the bottom side of the steering column, by virtue of being disposed on the upper side. Consequently, the driver does not unexpectedly bump his/her knees.

As shown in FIGS. 1 and 7, a tilt contact face 47 of the upper side of the upper bracket 4 is disposed so as to abut a tilt contact face 46 of the upper side of the middle bracket 3 during flip-up of the steering wheel. Accordingly, the upper bracket 4, the steering wheel, and the like are supported by the middle bracket 3 side by way of the tilt contact faces 46 and 47. Also, tilt angles of the contact faces 46 and 47 are set at their angles of friction or less.

Note that, during normal driving, a lower-side contact face 47 of the upper bracket 4 abuts a lower-side contact face 48 of the middle bracket 3, as shown in FIG. 1, to thus serve as a stopper.

Further, as shown in FIGS. 2, 5, and 6, a locking mechanism of the flip-up mechanism is provided with a crank lever 52. The crank lever 52 is rotatable about a support pin 51 provided on the upper bracket 4, and bent at a plurality of points.

On a tip portion of the crank lever 52, a nipped piece 53 (locking piece) is provided. The nipped piece 53 is pinched and supported between the middle bracket 3 and the upper bracket 4, and comes out of a gap therebetween when the steering wheel is in the flip-up position.

The crack lever 52 is elastically urged, by a spring 54 disposed between the crank lever 52 and the upper bracket 4, in a direction where the nipped piece 53 (locking piece) is locked at all times (i.e., in such a direction as to be nipped between the pair of contact faces 46 and 47). Further, the nipped piece 53 (locking piece) is formed in a wedge shape so as to have a substantially identical angle with the tilt angle of the pair of contact faces 46 and 47. By virtue of this configuration, when the driver presses down the upper bracket 4 in order to return the steering wheel from a flip-up position to a normal driving position, the wedge-shaped nipped piece 53 (locking piece) is interposed in a gap between the contact faces 46 and 47 of the two brackets 3 and 4 by a spring tension of the spring 54 to thus be locked in place.

By virtue of the above-described constitution, when the driver causes the steering wheel to flip-up during stoppage of the vehicle or on another occasion, he/she rotates a control section 52a of the crank lever 52 against the spring tension of the spring 54 (i.e., counterclockwise in FIG. 6). Then, the nipped piece 53 (locking piece) comes out of the gap between the middle bracket 3 and the upper bracket 4, and the upper bracket 4 on the steering wheel side is automatically caused to flip-up by the spring tension of flip-up springs 45.

Consequently, the tilted contact face 47 of the upper bracket 4 is brought into contact with the tilted contact face 46 of the middle bracket 3, and the upper bracket 4, the steering wheel, and the like, are supported by the middle bracket 3 side by way of the contact faces 46 and 47. Consequently, under the flipped-up state, the driver can easily get on or off the vehicle.

Meanwhile, when returning the steering wheel from a flip-up position to a normal driving position, as in a case of driving the vehicle in the second time, the driver presses down the upper bracket 4 against the spring tension of the flip-up springs 45. Then, the wedge-shaped nipped piece 53 (locking piece) is interposed in the gap between the contact faces 46 and 47 of the two brackets 3 and 4 to thus be locked by spring tension of the spring 54.

At the time, re-adjustment is not required, because the tilt telescopic adjustment mechanism and the flip-up mechanism are provided independently in the embodiment, and the steering wheel has already been adjusted to the optimum driving position by the tilt telescopic adjustment mechanism when the driver has returned the steering wheel from the flip-up position to the normal driving position.

As described above, according to the first embodiment, because the flip-up mechanism for causing flip-up of the steering wheel is provided separately at a position closer to the steering wheel side in relation to the clamping section of the position adjustment mechanism, ease of getting in/out action of the driver can be enhanced considerably while the number of control levers 33 and 52 is suppressed to only two with a vehicle steering column device based on the steering mechanism of tilt/telescopic type.

(Second Embodiment)

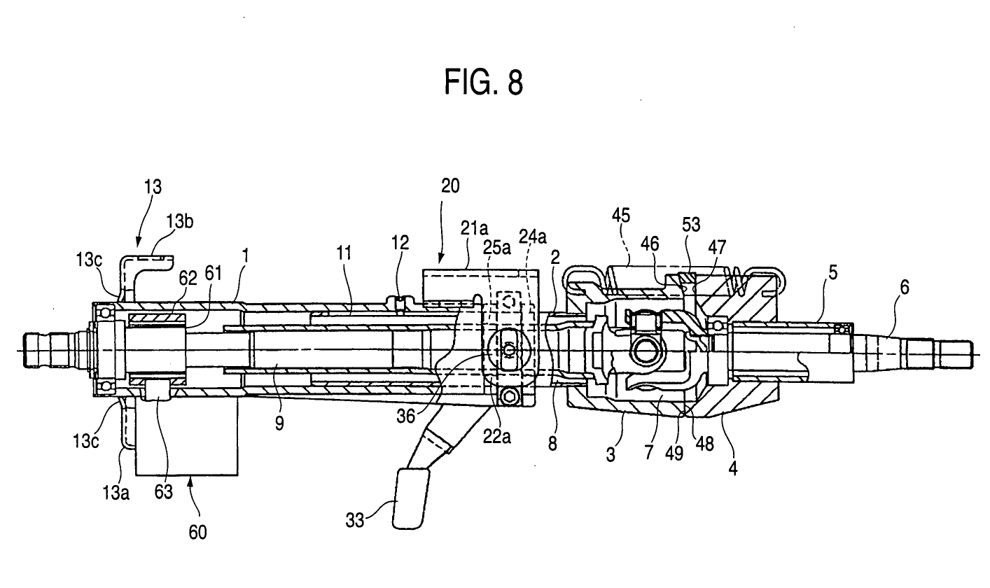

FIG. 8 is a longitudinal cross-sectional view of a vehicle steering column according to a second embodiment of the invention.

The second embodiment differs from the first embodiment in that an electric steering lock-device is added.

Conventionally, in the case of the steering column of oscillatory tilt type (a type where the tilt center is placed close to the driver, and the tilt center and a tilt position fixing mechanism are disposed close to each other), a steering lock is fixed in the center portion of a column main body (the lower bracket). In the case of the oscillatory-tilt-type steering column, even when position adjustment of tilt type, or the like, has been performed, no relative displacement occurs between the column main body (the lower bracket) and the body of the vehicle. Accordingly, a tip of a key cylinder of the steering lock can be fixed on an instrument panel.

However, the above-described first embodiment employs the steering column of swingable tilt type(a type where the tilt center is placed distant from the driver, and the tilt center and a tilt position fixing mechanism are disposed away from each other), and the column main body (the lower bracket) moves in conjunction with a tilt. In such a case, the end portion of a key cylinder section of a conventional steering lock cannot be fixed on the instrument panel.

Accordingly, the second embodiment adopts an electrical steering lock whose key cylinder section and lock section are formed separately. By means operating a lock electrically, the key cylinder section can be fixed on an instrument panel as in the conventional steering lock.

As shown in FIG. 8, in the second embodiment, a lock section 60 is provided on the lower column 1 of the steering column.

Specifically, a key lock collar 62 is attached on the lower shaft 9 of a steering shaft by way of a slide ring 61. The lock section 60 is composed so that a locking key bolt 63 which is to fit in respective key grooves of the key lock collar 62 can be advanced or receded by an unillustrated electric actuator.

Other configurations, operations, and advantages of the second embodiment are the same as those of the first embodiment described above.

(Third Embodiment)

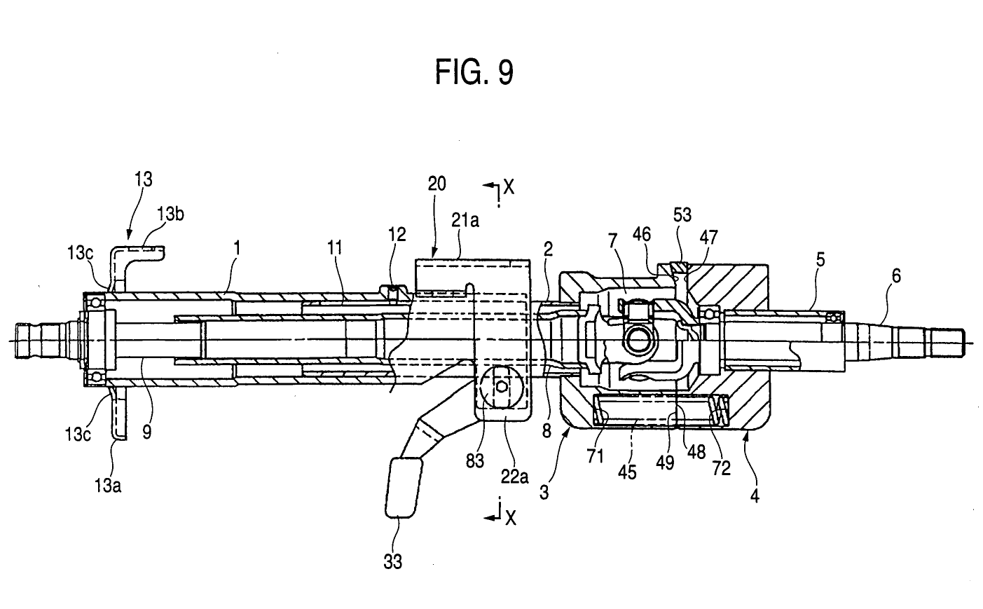

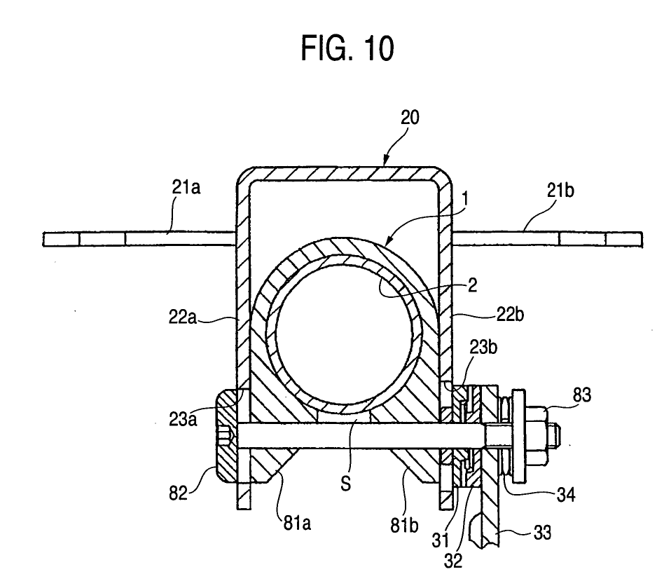

FIG. 9 is a longitudinal cross-sectional view of a vehicle steering column device according to a third embodiment of the invention. FIG. 10 is a cross-sectional view taken along line X-X of FIG. 9.

The third embodiment differs from the first embodiment in that the flip-up springs 45 are disposed on the lower side of the steering column and changed to helical compression springs.

In the third embodiment, as shown in FIG. 9, the flip-up springs 45 formed from helical compression springs are housed in a compressed state in a pair of retraction portions 71 and 72 respectively formed in the middle bracket 3 and the upper bracket 4. Consequently, when flip-up locking of the flip-up mechanism is released, the upper bracket 4 provided on the steering wheel side is arranged so as to automatically cause flip-up operation by means of spring tension of the flip-up springs 45 formed from the helical compression springs.

Note that the constitution has a disadvantage in that an overhanging portion on the lower side of the column becomes larger than that in the first embodiment. However, the present embodiment is advantageous over the first embodiment in that the mechanism is simplified and in that cost is reduced because a number of components for the tilt/telescopic clamping section is reduced.

In the third embodiment, the tilt/telescopic clamping section is changed from a type where the axis of the tilt fastening bolts (35 and 36) intersects the axis of the steering shafts (6 through 9) substantially perpendicularly, to a type where the axis of the tilt fastening bolts (35 and 36) is deviated from the axis of the steering shafts (6 through 9).

Specifically, as shown in FIG. 10, in the type where the axis of the tilt fastening bolts (35 and 36) is deviated from the axis of the steering shafts (6 through 9), an axial slit S is formed in the lower center on the vehicle-rear-side of the lower column 1, and a pair of clamping sections 81a and 81b for embracing and clamping the telescopic column 2 located on the upper side are formed. The clamping sections 81a and 81b each have an inner peripheral face whose shape matches an outer peripheral surface of the telescopic column 2 on the upper side. The clamping sections 81a and 81b also have an outer peripheral face which contacts with the insides of the pair of opposing flat plate sections 22a and 22b, respectively.

A clamp bolt 82 is inserted at a position which is lower than the pair of clamping portions 81a and 81b; namely, at a position offset from the steering column. An adjustment nut 83 is secured on the clamp bolt 82 through screw-engagement by way of a cam mechanism including the pair of cam members 31 and 32, the control lever 33 for tilt telescopic control, and the thrust bearing 34. The adjustment nut 83 is one equipped with a release-preventing mechanism, such as a caulking nut or a nut having locking resin, or a nut with a release-preventing mechanism.

Further, a screw-type fastening mechanism may be used instead of the cam mechanism formed from the pair of cam members 31 and 32.

The operation of tilt telescopic adjustment of the steering column device according to the embodiment will now be described.

When the control lever 33 is rotated in a fastening direction, the protruding portions of the first cam member 31 and the second cam member 32 are engaged with each other as shown in FIG. 10, to thus generate pressing force urging the cam members away from each other.

Consequently, the flat plate section 22b, which has been pressed by the first cam member 31, is displaced to the left in FIG. 10.

Meanwhile, the adjustment nut 83 having been pressed to the right by the second cam member 32 displaces the clamp bolt 82 to the right. Consequently, the flat plate section 22a, the other one of the opposing flat plate sections, is displaced to the right in FIG. 10.

As described above, when the pair of opposing flat plate sections 22a and 22b are moved in the fastening direction (i.e., in the direction narrowing the gap thereof), the pair of clamping portions 81a and 81b are pressed so as to be urged closer to each other and are resultantly shortened in diameter. As a result, the telescopic column 2 on the upper side is fastened, thereby effecting tilt/telescopic fastening.

In contrast, when the control lever 33 is rotated in a releasing direction, the first cam member 31 and the second cam member are displaced in a direction to become closer due to engagement of the recessed portions and the protruding portions thereof, and the gap therebetween is narrowed.

As a result, pressing on the opposing flat plate section 22b by the first cam member 31 is released, and pressing on the second cam member 32 against the opposing flat plate section 22a by way of the adjustment nut 83 and the clamp bolt 82 is 15 also released.

As described above; when pressing on the pair of opposing flat plate sections 22a and 22b is released, the pair of clamping portions 81a and 81b are moved away from each other, whereby the diameters of the clamping portions 81a, 81b are increased. Accordingly, fastening to the telescopic column 2 on the upper side is released, to thus release the tilt telescopic fastening. Consequently, the driver can perform a tilt or telescopic adjustment.

Other configurations, operation, and advantages are the same as those of the first embodiment described above.

(Fourth Embodiment)

In a fourth embodiment, although not particularly illustrated, the steering column device is configured so that the wedge-shaped nipped piece 53 (locking piece) can be released by an unillustrated electric actuator. By virtue of this configuration, the driver can cause flip-up of the steering wheel, or the like, by merely pressing a switch or the like.

Further, in the case of a constitution in which the wedge-shaped nipped piece 53 (locking piece) is released by an electric actuator, the electric actuator may be caused to operate in conjunction with insertion of an ignition key.

The present invention is not limited to the embodiments described above but maybe susceptible to various modifications.

As described above, according to the first embodiment, the flip-up mechanism for causing flip-up of the steering wheel is provided separately at a position closer to the steering wheel side in relation to the clamping section of the position adjustment mechanism, and therefore ease of getting in/out action of the driver can be enhanced considerably while the number of control levers is suppressed to an extreme extent (e.g., to a number of two) with a vehicle steering column device based on a steering mechanism of swingable-tilt/telescopic type which exhibits very excellent drivability.

What is claimed is:

1. A vehicle steering column device for adjusting a position of a steering wheel at a desired position, the device comprising:
a steering column connected to the steering position;
a position adjustment mechanism for adjusting a position of the steering column; the position adjustment mechanism including a clamping section for clamping the steering column at a desired position; and
a flip-up mechanism for causing flip-up of the steering wheel, the flip-up mechanism separately disposed at a position closer to the steering wheel with respect to the clamping section.

2. The vehicle steering column device according to claim 1,
wherein the flip-up mechanism includes:
a stationary bracket fixed to the steering column;
a swaying bracket disposed in a swayable manner on a vehicle rear side of the stationary bracket; and
a nipped piece nipped between the stationary bracket and the swaying bracket, the nipped piece capable of coming out of a gap between the stationary bracket and the swaying bracket at a time of flip-up of the steering wheel.

3. The vehicle steering column device according to claim 2,
wherein the stationary bracket and the tilt bracket are brought into contact with each other through a contacting surface at the time of flip-up of the steering wheel; and
a tilt angle of the contacting surface is set to be an angle of friction or less.

4. The vehicle steering column device according to claim 1, further comprising: a steering lock of an electric type having a lock section that is provided separately from a key cylinder section;
wherein the lock section is placed on the steering column.

5. The vehicle steering column device according to claim 2,
wherein the position adjustment mechanism further includes a tilt clamping bolt having an axis that intersects substantially perpendicular to an axis of a steering shaft; and
the flip-up mechanism has a flip-up spring disposed at a position above the steering column and above the stationary bracket and the swaying bracket.

6. The vehicle steering column device according to claim 1,
wherein the position adjustment mechanism has a tilt swaying center disposed at a position lower than the clamping section of the steering column.

7. The vehicle steering column device according to claim 2,
wherein the flip-up mechanism further comprises a flip-up control lever for actuating the nipped piece through operation performed by an operator.

8. The vehicle steering column device according to claim 7,
wherein the flip-up control lever is attached on the swaying bracket.

9. The vehicle steering column device according to claim 1,
wherein the position adjustment mechanism employs an adjustment of tilt type for adjusting the position of the steering column.

10. The vehicle steering column device according to claim 1,
wherein the position adjustment mechanism employs an adjustment of telescopic type for adjusting the position of the steering column.

11. The vehicle steering column device according to claim 1,
wherein the position adjustment mechanism employs an adjustment of tilt/telescopic type for adjusting the position of the steering column.
